(19) United States
(12) Patent Application Publication
(10) Pub. No.: US 2025/0035894 A1
(43) Pub. Date: Jan. 30, 2025

(54) HEAD-MOUNTED DISPLAY DEVICE AND ZOOMABLE CURVED OPTICAL DEVICE THEREOF

(71) Applicants: INTERFACE TECHNOLOGY (CHENGDU) CO., LTD., Chengdu City (CN); INTERFACE OPTOELECTRONICS (SHENZHEN) CO., LTD, Shenzhen City (CN); GENERAL INTERFACE SOLUTION LIMITED, Miaoli County (TW)

(72) Inventors: KUN-CHIH HUNG, SHENZHEN CITY (CN); TING-HUI CHEN, SHENZHEN CITY (CN); PO-LUN CHEN, SHENZHEN CITY (CN); YUN-PEI CHEN, SHENZHEN CITY (CN)

(21) Appl. No.: 18/460,879

(22) Filed: Sep. 5, 2023

(30) Foreign Application Priority Data
Jul. 27, 2023 (CN) 202310938932X

(51) Int. Cl. G02B 13/00; G02B 15/00

(52) U.S. Cl. CPC G02B 13/0055; G02B 15/00; G02B 5/3083; G02F 1/0136

(57) ABSTRACT

A head-mounted display device and a zoomable curved optical device thereof is disclosed. The zoomable curved optical device includes a curved polarization reflection film, a waveplate, a half-mirror film, and a zoomable module. The waveplate has a first surface and a second surface opposite to each other. The half-mirror film is arranged on the first surface of the waveplate. The zoomable module is adhered to the second surface of the waveplate with an optical adhesive. The curved polarization reflection film is arranged on the zoomable module. The head-mounted display device and the zoomable curved optical device thereof adopt a polarization reflection film with the shorter radius of curvature to have lightweight and slim properties.

This application claims priority for the CN patent application No. 202310938932X filed on 27 Jul. 2023, the content of which is incorporated by reference in its entirely.

### BACKGROUND OF THE INVENTION

### Field of the Invention

The present invention relates to display technology, particularly to a head-mounted display device and a zoomable curved optical device thereof.

### Description of the Related Art

With the rapid development of science and technology, people's demand for multimedia video information is increasing day by day. Generally, common multimedia playback devices are equipped with liquid crystal displays (LCDs) or light-emitting diode (LED) displays to display images. However, the pixels and size of images displayed by the display will be limited by the size and performance of the display. The visual effect of the display is limited. It is easy to cause eye fatigue when the display is used for a long time.

Therefore, a head-mounted display (HMD) has appeared on the market. The head-mounted display is an optical product for stereoscopic vision display. It transmits the signal with the stereoscopic effect of binocular disparity to the eyes through the display elements and optical lenses arranged in front of the eyes in sequence, thereby producing a stereoscopic and large-image. Head-mounted displays are usually used in augmented reality (AR) systems or virtual reality (VR) systems. In addition to moving with the user, the HMD can also be used as an input device to receive the user's response. Besides, images and texts can also be added to the images watched by users to achieve the effect of virtual reality or augmented reality. However, the current VR glasses are implemented with plane polarized mirrors. If a higher diopter is desired, the thickness of the VR glasses must be increased, which will cause inconvenience to users.

To overcome the abovementioned problems, the present invention provides a head-mounted display device and a zoomable curved optical device thereof, so as to solve the afore-mentioned problems of the prior art.

### SUMMARY OF THE INVENTION

The present invention provides a head-mounted display device and a zoomable curved optical device thereof to have light and thin properties.

In an embodiment of the present invention, a zoomable curved optical device includes a curved polarization reflection film, a waveplate, a half-mirror film, and a zoomable module. The waveplate has a first surface and a second surface opposite to each other. The half-mirror film is arranged on the first surface of the waveplate. The zoomable module is arranged on the second surface of the waveplate through an optical adhesive. The curved polarization reflection film is arranged on the zoomable module.

In an embodiment of the present invention, the waveplate is a quarter waveplate.

In an embodiment of the present invention, the half-mirror film is a curved half-mirror film.

In an embodiment of the present invention, the zoomable module includes at least one polarization dependent lens, at least one first solid lens, at least one second solid lens, a first polarization controller and a second polarization controller. The first solid lens and the second solid lens are respectively arranged on two opposite sides of the polarization dependent lens. The first polarization controller is arranged on the second surface of the waveplate through the optical adhesive and arranged between the first solid lens and the waveplate. The second polarization controller is arranged between the second solid lens and the curved polarization reflection film.

In an embodiment of the present invention, the first solid lens and the second solid lens are aspherical lenses.

In an embodiment of the present invention, the first solid lens and the second solid lens are non-polarization dependent lenses.

In an embodiment of the present invention, the polarization dependent lens is an aspherical lens.

In an embodiment of the present invention, the first surface of the waveplate faces toward the display surface of a display module through the half-mirror film and the display module is configured to transmit circularly-polarized images to the half-mirror film.

In an embodiment of the present invention, the display module is a liquid-crystal display, a micro-organic light-emitting diode (μ-OLED) module, a liquid-crystal-on-silicon display module, a digital light-processing module, or micro light-emitting diode display module.

In an embodiment of the present invention, the zoomable module is configured to control the diopter of incident light and maintain or change the polarization state of an incident polarized image according to the polarization state of the incident polarized image.

In an embodiment of the present invention, a head-mounted display device includes a curved polarization reflection film, a waveplate, a half-mirror film, a zoomable module, and a display module. The waveplate has a first surface and a second surface opposite to each other. The half-mirror film is arranged on the first surface of the waveplate. The zoomable module is arranged on the second surface of the waveplate through an optical adhesive. The curved polarization reflection film is arranged on the zoomable module. The display module has a display surface that faces toward the first surface of the waveplate through the half-mirror film. The display module is configured to transmit circularly-polarized images to the half-mirror film.

In an embodiment of the present invention, the waveplate is a quarter waveplate.

In an embodiment of the present invention, the half-mirror film is a curved half-mirror film.

In an embodiment of the present invention, the zoomable module includes at least one polarization dependent lens, at least one first solid lens, at least one second solid lens, a first polarization controller and a second polarization controller. The first solid lens and the second solid lens are respectively arranged on two opposite sides of the polarization dependent lens. The first polarization controller is arranged on the second surface of the waveplate through the optical adhesive and arranged between the first solid lens and the waveplate. The second polarization controller is arranged between the second solid lens and the curved polarization reflection film.

In an embodiment of the present invention, the first solid lens and the second solid lens are aspherical lenses.

In an embodiment of the present invention, the first solid lens and the second solid lens are non-polarization dependent lenses.

In an embodiment of the present invention, the polarization dependent lens is an aspherical lens.

In an embodiment of the present invention, the display module is a liquid-crystal display, a micro-organic light-emitting diode (μ-OLED) module, a liquid-crystal-on-silicon display module, a digital light-processing module, or micro light-emitting diode display module.

In an embodiment of the present invention, the zoomable module is configured to control the diopter of incident light and maintain or change the polarization state of an incident polarized image according to the polarization state of the incident polarized image.

In an embodiment of the present invention, the head-mounted display device and the zoomable curved optical device employ the polarization reflection film with the shorter radius of curvature to have light and thin properties without changing the optical efficiency.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram illustrating the Pancake lens;

FIG. 2 is a schematic diagram illustrating a concave reflector for reflecting light rays;

FIG. 3 is a schematic diagram illustrating a head-mounted display device and a zoomable curved optical device according to a first embodiment of the present invention;

FIG. 4 is a schematic diagram illustrating a convex reflector for reflecting light rays; and

FIG. 5 is a cross-sectional view of a head-mounted display device and a zoomable curved optical device according to a second embodiment of the present invention.

### DETAILED DESCRIPTION OF THE INVENTION

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

Throughout the description and claims, it will be understood that when a component is referred to as being “positioned on,” “positioned above,” “connected to,” “engaged with,” or “coupled with” another component, it can be directly on, directly connected to, or directly engaged with the other component, or intervening component may be present. In contrast, when a component is referred to as being “directly on,” “directly connected to,” or “directly engaged with” another component, there are no intervening components present.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment.

The invention is particularly described with the following examples which are only for instance. Those skilled in the art will readily observe that numerous modifications and alterations of the device and method may be made while retaining the teachings of the invention. Accordingly, the following disclosure should be construed as limited only by the metes and bounds of the appended claims. In the whole patent application and the claims, except for clearly described content, the meaning of the articles “a” and “the” includes the meaning of “one or at least one” of the elements or components. Moreover, in the whole patent application and the claims, except that the plurality can be excluded obviously according to the context, the singular articles also contain the description for the plurality of elements or components. In the entire specification and claims, unless the contents clearly specify the meaning of some terms, the meaning of the article “wherein” includes the meaning of the articles “wherein” and “whereon”. The meanings of every term used in the present claims and specification refer to a usual meaning known to one skilled in the art unless the meaning is additionally annotated. Some terms used to describe the invention will be discussed to guide practitioners about the invention. The examples in the present specification do not limit the claimed scope of the invention.

Certain terms are used throughout the description and the claims to refer to particular components. One skilled in the art appreciates that a component may be referred to using different names. This disclosure does not intend to distinguish between components that differ in name but not in function. In the description and in the claims, the term “comprise” is used in an open-ended fashion, and thus should be interpreted to mean “include, but not limited to.” The phrases “be coupled to,” “couples to,” and “coupling to” are intended to encompass any indirect or direct connection. Accordingly, if this disclosure mentions that a first device is coupled with a second device, it means that the first device may be directly or indirectly connected to the second device through electrical connections, wireless communications, optical communications, or other signal connections with/without other intermediate devices or connection means.

Unless otherwise specified, some conditional sentences or words, such as “can”, “could”, “might”, or “may”, usually attempt to express what the embodiment in the present invention has, but it can also be interpreted as a feature, element, or step that may not be needed. In other embodiments, these features, elements, or steps may not be required.

In the following description, a head-mounted display device and a zoomable curved optical device will be provided, which employ a polarization reflection film with the shorter radius of curvature to have light and thin properties without changing the optical efficiency.

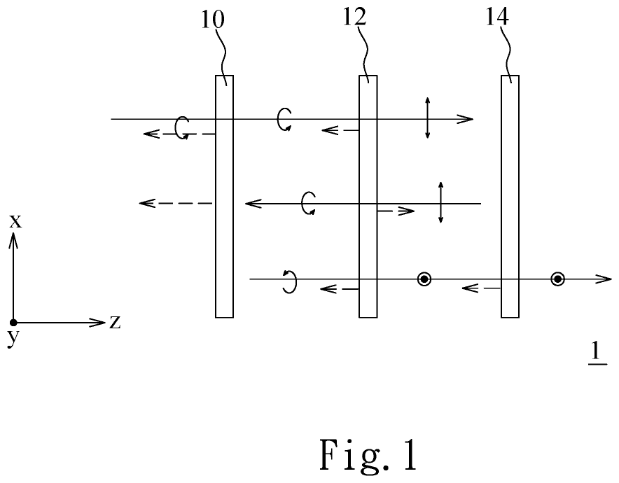

FIG. 1 is a schematic diagram illustrating the Pancake lens. In the development of head-mounted displays, especially virtual reality (VR) displays, the Pancake lens has become mainstream because it can fold the optical path and reduce weight and space. The principle of the Pancake lens is to convert the polarization state of polarized light and reflect the polarized light, so as to achieve the effect of folding the optical path between the half mirror and the reflective polarizer. Because the optical path is folded, the light can pass through the lens located between the half mirror and the reflective polarizer three times. Thus, the lens located between the half mirror and the reflective polarizer in the Pancake lens can contribute diopters three times, such that the Pancake lens has a thin and small volume. As illustrated in FIG. 1, the Pancake lens 1 includes a half mirror 10, a quarter waveplate 12, and a reflective polarizer 14. The half mirror 10 reflects half of the light, such that half of the light passes through the half mirror 10. The half mirror 10 changes the polarization state of the circularly-polarized light, such as reflecting left circularly-polarized light to form right circularly-polarized light or reflecting right circularly-polarized light to form left circularly-polarized light. The quarter waveplate 12 converts circularly-polarized light into linearly-polarized light or converts linearly-polarized light into circularly-polarized light. The reflective polarizer 14 reflects linearly-polarized light in a first direction and linearly polarized light in a second direction passes through the reflective polarizer 14. The first direction is perpendicular to the second direction. In FIG. 1, both the solid line arrow and the dotted line arrow represent the traveling direction of light. The right circularly-polarized light passes through the half mirror 10 and the quarter waveplate 12 in sequence. The quarter waveplate 12 converts the right circularly-polarized light into x polarized light. The reflective polarizer 14 reflects x polarized light. The quarter waveplate 12 converts x polarized light into right circular-polarized light. The half mirror 10 reflects right circularly-polarized light to form left circularly-polarized light. The left circular-polarized light passes through the quarter waveplate 12 to form y polarized light. The y polarized light directly passes through the reflective polarizer 14. The Pancake lens is applied to the head-mounted display device and the zoom optical device thereof of the present invention.

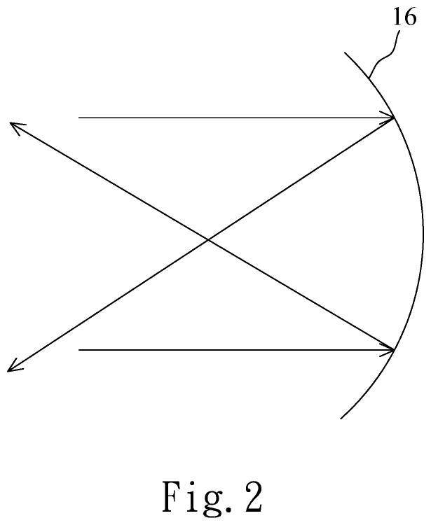

FIG. 2 is a schematic diagram illustrating a concave reflector for reflecting light rays. Referring to FIG. 2, the direction of the light ray is indicated by an arrow. When the parallel light rays are reflected by the concave surface of a concave reflector 16, the light rays are converged to increase the diopter of the light rays. The principle of the concave reflector 16 increasing the diopter of light rays is applied to the head-mounted display device and the zoomable curved optical device of the present invention.

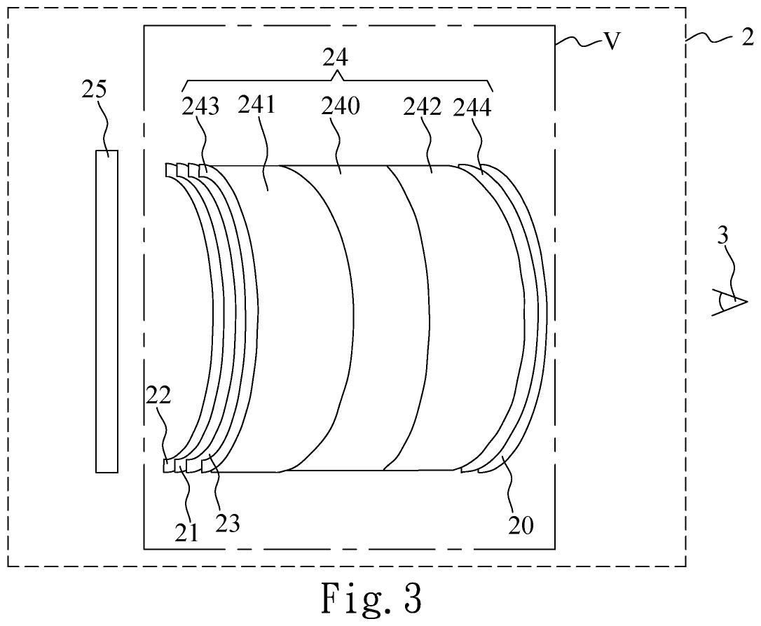

FIG. 3 is a schematic diagram illustrating a head-mounted display device and a zoomable curved optical device according to a first embodiment of the present invention. Referring to FIG. 3, the first embodiment of a head-mounted display 2 is introduced as follows. The head-mounted display 2 includes a zoomable curved optical device V. The zoomable curved optical device V includes a curved polarization reflection film 20, a waveplate 21, a half-mirror film 22, an optical adhesive 23, and a zoomable module 24. In addition to the zoomable curved optical device V, the head-mounted display 2 further includes a display module 25. The waveplate 21 may be, but not limited to, a quarter waveplate. The display module 25 may be, but not limited to, a liquid-crystal display, a micro-organic light-emitting diode (μ-OLED) module, a liquid-crystal-on-silicon display module, a digital light-processing module, or micro light-emitting diode display module. The waveplate 21 has a first surface and a second surface opposite to each other. The half-mirror film 22 is arranged on the first surface of the waveplate 21. The zoomable module 24 is arranged on the second surface of the waveplate 21 through the optical adhesive 23. The curved polarization reflection film 20 is arranged on the zoomable module 24. Since the concave surface of the curved polarization reflection film 20 faces toward the display surface of the display module 25, the diopter of the zoomable curved optical device V can be increased. The half-mirror film 22 may be a curved half-mirror film whose concave surface can face toward the display surface of the display module 25 to increase the diopter of the zoomable curved optical device V. The first surface of the waveplate 21 faces toward the display surface of the display module 25 through the half-mirror film 22. The display module 25 is configured to transmit circularly-polarized images to the half-mirror film 22.

In some embodiments of the present invention, the zoomable module may further include at least one polarization dependent lens 240, at least one first solid lens 241, at least one second solid lens 242, a first polarization controller 243, and a second polarization controller 244. For clarity and convenience, the number of each of the polarization dependent lens 240, the first solid lens 241, and the second solid lens 242 is one. In a preferred embodiment, the polarization dependent lens 240, the first solid lens 241, and the second solid lens 242 are aspherical lenses. Each of the first solid lens 241 and the second solid lens 242 may have the radius of curvature of 50-300 mm. The first solid lens 241 and the second solid lens 242 may include glass or plastic and provide the necessary diopters to meet the requirement of the head-mounted display device 2. Specifically, the first solid lens 241 and the second solid lens 242 may be non-polarization dependent lenses. The polarization dependent lens 240 changes the refractive index and the focal length according to the polarization state of the incident light, where the focal length is the reciprocal of the diopter. The polarization dependent lens 240 may include a birefringent material. The polarization dependent lens 240 may be a liquid crystal polymer lens, a birefringent water glue or a curved phase retarder. The first solid lens 241 and the second solid lens 242 are respectively arranged on two opposite sides of the polarization dependent lens 240. The first polarization controller 243 is arranged on the second surface of the waveplate 21 through the optical adhesive 23 and arranged between the first solid lens 241 and the waveplate 21. The second polarization controller 244 is arranged between the second solid lens 242 and the curved polarization reflection film 20. In general, each of the first polarization controller 243 and the second polarization controller 244 may have two conductive light-transmitting substrates and a liquid-crystal layer therebetween. When the two conductive light-transmitting substrates are biased, the alignment direction of the liquid crystal molecules in the liquid-crystal layer is changed to change the polarization state of the incident light.

The zoomable module 24 controls the diopter of the incident light and maintains or changes the polarization state of an incident polarized image according to the polarization state of the incident polarized image. Specifically, when the display module 25 emits left circularly-polarized light, the left circularly-polarized light passes through the half-mirror film 22 and the waveplate 21 in sequence to form horizontally-polarized light. When the horizontally polarized light passes through the optical adhesive 23, the first polarization controller 243, the first solid lens 241, the polarization dependent lens 240, the second solid state lens 242, and the second polarization controller 244 in sequence, the focal length and diopter of the zoomable module 24 are determined according to the polarization state of the horizontally-polarized light. When the horizontally-polarized light passes through the second polarization controller 244, the second polarization controller 244 can maintain the polarization state of the horizontally-polarized light or convert the horizontally-polarized light into vertically-polarized light. When the second polarization controller 244 converts the horizontally-polarized light into vertically-polarized light, the vertically-polarized light passes through the curved polarization reflection film 20 and enters a human eye 3. If the second polarization controller 244 maintains the polarization state of the horizontally polarized light, the curved polarization reflection film 20 reflects the horizontally-polarized light, so that the horizontally-polarized light passes through the zoomable module 24, the optical adhesive 23, the waveplate 21 and the half-mirror film 22 in sequence. The waveplate 21 converts the horizontally-polarized light into left circularly-polarized light. The half-mirror film 22 reflects the left circularly-polarized light to form right circularly-polarized light. When the right circularly-polarized light passes through the waveplate 21, the waveplate 21 converts the right circularly-polarized light into vertically-polarized light. The vertically-polarized light passes through the optical adhesive 23, the zoomable module 24 and the curved polarization reflection film 20 in sequence and enters the human eye 3.

The curved polarization reflection film 20 can be used to adjust aberrations to improve optical imaging quality, wherein the radius R of curvature of the curved polarization reflection film 20 is 50-300 mm, as shown in Table 1.

TABLE 1

diopter(m⁻¹)

| R(mm) | lens | reflection |
|---|---|---|
| 50 | 10 | 40 |
| 100 | 5 | 20 |
| 150 | 3.33 | 13.33 |
| 200 | 2.5 | 10 |
| 250 | 2 | 8 |
| 300 | 1.67 | 6.67 |

As shown in Table 1, different R values correspond to the variations of the diopter and the additional diopter values that can be provided after the incident light is reflected by the curved surface. For example, when the incident light is not reflected by the curved surface, the curved polarization reflection film 20 with R of 50 mm will provide a diopter of 10 m⁻¹. If the incident light is reflected by the curved surface, the diopter of 50 m⁻¹ can be obtained. In addition, if the curved surface of the curved polarization reflection film 20 with R of 250 mm reflects the incident light, the diopter of 10 m⁻¹ can be also obtained, which will be the same as the diopter of the curved polarization reflection film 20 with R of 50 mm. Therefore, under the premise of obtaining the same diopter, the zoomable curved optical device can be made thinner by forming the curved polarization reflection film 20. That is to say, in order to obtain the same diopter, the zoomable curved optical device becomes the thinner when the radius of curvature of the curved polarization reflection film 20 is the longer. Therefore, the head-mounted display device and the zoomable curved optical device adopt the polarization reflection film with a shorter radius of curvature without changing the optical effect, so as to have light and thin properties.

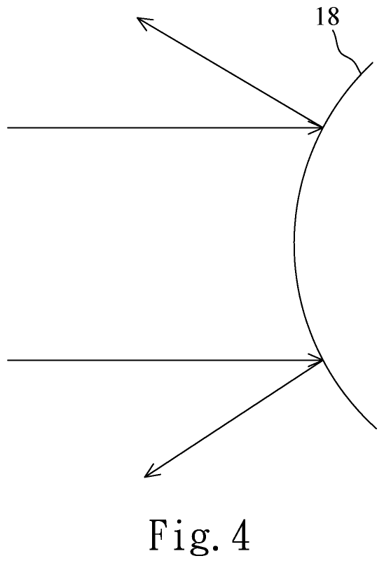

FIG. 4 is a schematic diagram illustrating a convex reflector for reflecting light rays. Referring to FIG. 4, the direction of light rays is indicated by an arrow. When the parallel light rays are reflected by the convex surface of a convex reflector 18, the light rays are diverged to reduce the diopter of the light rays. The principle of the convex reflector 18 reducing the diopter of light rays can also be applied to the head-mounted display device and the zoomable curved optical device of the present invention.

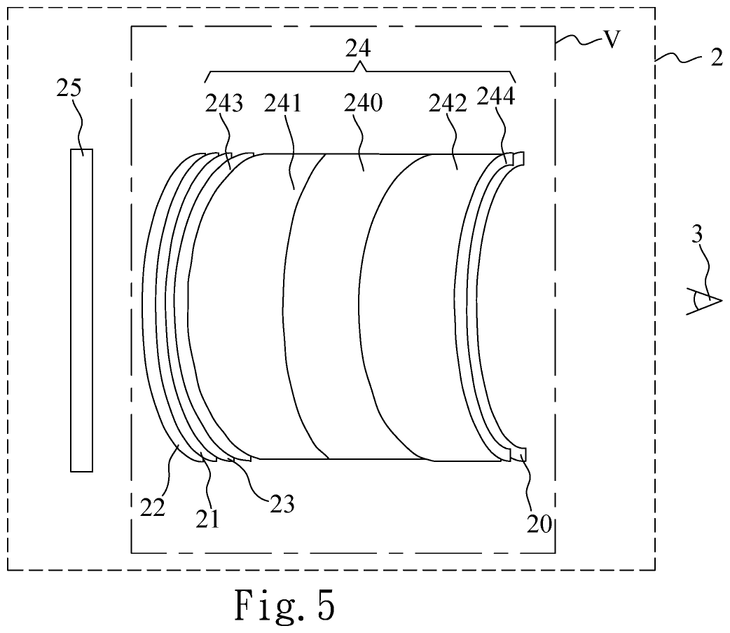

FIG. 5 is a cross-sectional view of a head-mounted display device and a zoomable curved optical device according to a second embodiment of the present invention. Referring to FIG. 5, the second embodiment of the head-mounted display device 2 is introduced as follows. The second embodiment is different from the first embodiment in the half-mirror film 22 and the curved polarization reflection film 20. In the second embodiment, the convex surfaces of the half-mirror film 22 and the curved polarization reflection film 20 face toward the display surface of the display module 25. The other technical features of the second embodiment are the same as those of the first embodiment so they will not be reiterated.

According to the embodiments provided above, the head-mounted display device and the zoomable curved optical device have light and thin properties.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A zoomable curved optical device comprising:
a curved polarization reflection film;
a waveplate having a first surface and a second surface opposite to each other;
a half-mirror film arranged on the first surface of the waveplate; and
a zoomable module arranged on the second surface of the waveplate through an optical adhesive, wherein the curved polarization reflection film is arranged on the zoomable module.

2. The zoomable curved optical device according to claim 1, wherein the waveplate is a quarter waveplate.

3. The zoomable curved optical device according to claim 1, wherein the half-mirror film is a curved half-mirror film.

4. The zoomable curved optical device according to claim 1, wherein the zoomable module comprises:
at least one polarization dependent lens;
at least one first solid lens and at least one second solid lens respectively arranged on two opposite sides of the at least one polarization dependent lens;
a first polarization controller arranged on the second surface of the waveplate through the optical adhesive and arranged between the at least one first solid lens and the waveplate; and
a second polarization controller arranged between the at least one second solid lens and the curved polarization reflection film.

5. The zoomable curved optical device according to claim 4, wherein the at least one first solid lens and the at least one second solid lens are aspherical lenses.

6. The zoomable curved optical device according to claim 4, wherein the at least one first solid lens and the at least one second solid lens are non-polarization dependent lenses.

7. The zoomable curved optical device according to claim 4, wherein the at least one polarization dependent lens is an aspherical lens.

8. The zoomable curved optical device according to claim 1, wherein the first surface of the waveplate faces toward a display surface of a display module through the half-mirror film and the display module is configured to transmit circularly-polarized images to the half-mirror film.

9. The zoomable curved optical device according to claim 8, wherein the display module is a liquid-crystal display, a micro-organic light-emitting diode (μ-OLED) module, a liquid-crystal-on-silicon display module, a digital light-processing module, or micro light-emitting diode display module.

10. The zoomable curved optical device according to claim 1, wherein the zoomable module is configured to control a diopter of incident light and maintain or change a polarization state of an incident polarized image according to the polarization state of the incident polarized image.

11. A head-mounted display device comprising:
a curved polarization reflection film;
a waveplate having a first surface and a second surface opposite to each other;
a half-mirror film arranged on the first surface of the waveplate; and
a zoomable module arranged on the second surface of the waveplate through an optical adhesive, wherein the curved polarization reflection film is arranged on the zoomable module; and
a display module whose display surface faces toward the first surface of the waveplate through the half-mirror film, wherein the display module is configured to transmit circularly-polarized images to the half-mirror film.

12. The head-mounted display device according to claim 11, wherein the waveplate is a quarter waveplate.

13. The head-mounted display device according to claim 11, wherein the half-mirror film is a curved half-mirror film.

14. The head-mounted display device according to claim 11, wherein the zoomable module further comprises:
at least one polarization dependent lens;
at least one first solid lens and at least one second solid lens respectively arranged on two opposite sides of the at least one polarization dependent lens;
a first polarization controller arranged on the second surface of the waveplate through the optical adhesive and arranged between the at least one first solid lens and the waveplate; and
a second polarization controller arranged between the at least one second solid lens and the curved polarization reflection film.

15. The head-mounted display device according to claim 14, wherein the at least one first solid lens and the at least one second solid lens are aspherical lenses.

16. The head-mounted display device according to claim 14, wherein the at least one first solid lens and the at least one second solid lens are non-polarization dependent lenses.

17. The head-mounted display device according to claim 16, wherein the at least one polarization dependent lens is an aspherical lens.

18. The head-mounted display device according to claim 11, wherein the display module is a liquid-crystal display, a micro-organic light-emitting diode (μ-OLED) module, a liquid-crystal-on-silicon display module, a digital light-processing module, or micro light-emitting diode display module.

19. The head-mounted display device according to claim 11, wherein the zoomable module is configured to control a diopter of incident light and maintain or change a polarization state of an incident polarized image according to the polarization state of the incident polarized image.
